(19) United States
(12) Patent Application Publication
(10) Pub. No.: US 2008/0113166 A1
(43) Pub. Date: May 15, 2008

(54) Stamped Product Used to Seal Holes in a Durable Manner, in Particular in Sheet or in Plastic Pieces on Car Bodies

(75) Inventors: Frank Kolmorgen, Hamburg (DE); Torben Quednau, Hamburg (DE); Andreas Meier, Hamburg (DE); Patrick Gehringer, Bois le Roi (FR); Audrey Bohmer, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, HAMBURG (DE)

(21) Appl. No.: 11/719,384

(22) PCT Filed: Nov. 1, 2005
(86) PCT No.: PCT/EP05/55679

§ 371 Date: Jul. 17, 2007

(30) Foreign Application Priority Data
Nov. 16, 2004 (DE) 10 2004 055 324.6

(51) Int. Cl. B32B 7/02

(52) U.S. Cl. 428/212

(57) ABSTRACT

A stamped product for permanently obturating holes, especially in metal sheets or plastic parts of automobile bodies,
having an at least partly single-sidedly self-adhesively treated base layer comprising a heat-resistant backing whose area is greater than the area of the hole to be obturated and which is provided, in particular centrally, on the adhesively treated side with a first section of a heat-activable adhesive sheet whose area is greater than the area of the hole to be obturated and less than the area of the base layer, the stamped product being applied over the hole to be obturated, in such a way that the hole is substantially covered by the first section.

The present invention relates to a stamped product for permanently obturating holes, especially in metal sheets or plastic parts of automobile bodies.

In the course of the production of modern automobiles it is inevitable that during assembly holes of various sizes will come about as a consequence of the construction system in numerous individual parts such as metal sheets or plastic parts. The diameters of the holes are typically between 10 and 50 mm. In subsequent operation, many of these holes must be obturated in such a way that they are airtight and, in particular, watertight, in order to prevent corrosive attack by water or water vapor penetrating through the non-covered holes into the bodywork. An accompanying requirement is that of obturating the holes to achieve a considerable improvement in the suppression of noise in the passenger compartment.

At the present time, bodywork holes are generally obturated using plastic stoppers, which on the one hand do not reliably obturate the hole in certain cases and on the other hand are comparatively complicated and expensive to produce.

Each size of hole requires a specific stopper adapted to the size of hole. This involves high logistical and administration complexity and cost for the purchaser of the stoppers. On the production line, consequently, a large number of stoppers in different sizes, must be held, each in allocated storage compartments.

Additionally suitable for this purpose are adhesive tapes, which are stamped or separated into lengths to fit to the size of hole. Even adhesive tapes, however, do not always come up to the increasing requirements in the market.

It is an object of the present invention to provide a stamped product suitable for permanently obturating holes, especially in metal sheets or plastic parts of automobile bodies. A further intention is to ensure that said holes are obturated in such a way that the passage of moisture is excluded, the noise suppression is improved, and the holes are reliably obturated even in the event of stone chipping on the underbody and/or in the event of mechanical stresses in the interior, particularly in the floor area.

This object is achieved by means of a stamped product as set down in the main claim. The subclaims provide advantageous developments of the subject matter of the invention.

The invention accordingly provides a stamped product for permanently obturating holes, especially in metal sheets or plastic parts of automobile bodies, having an at least partly single-sidedly self-adhesively treated base layer comprising a heat-resistant backing whose area is greater than the area of the hole to be obturated and which is provided, in particular centrally, on the adhesively treated side with a first section of a heat-activable adhesive sheet.

The area of the first section is greater than the area of the hole to be obturated and less than the area of the base layer, the stamped product being applied over the hole to be obturated, in such a way that the hole is substantially covered by the first section.

In one advantageous embodiment of the invention, on the first section of the heat-activable adhesive sheet, and on the side facing the hole, there is a second section of a heat-activable thermoplastic adhesive sheet, whose area is greater than the area of the hole to be obturated and less than the area of the base layer, the stamped product, again, being applied over the hole to be obturated, in such a way that the hole is substantially covered by the second section.

The two sections of the heat-activable sheet preferably have the same dimensions. The purpose of the adhesive sheets is to join the stamped product permanently and securely to the substrate (generally the automobile body) following heat activation. The preferred second adhesive sheet section ensures the establishment, without application of pressure, of an effective, stable, and moisture-impermeable join between the first section and the substrate.

With further preference there is, between the base layer and the first section of the heat-activable adhesive sheet, a laminar body, which with particular advantage is composed of metal.

The laminar body has a high density or strength, so as to increase the noise suppression or strength of the stamped product as a whole.

The backing, which in one advantageous development of the invention is composed of an aluminum foil, a textile backing or a polymeric film (for example, PVC, PP, PET, PU), preferably has a thickness of
between 30 and 120 μm for the aluminum foil,
between 180 and 300 μm for a textile backing, and
between 30 and 300 μm for a film.

Backing material used for the stamped product in one particularly advantageous continuation of the invention comprises woven cotton fabric having in particular a mesh count of 140 to 160, preferably 148 (implying a warp thread count of 74 and a weft thread count of 74).

With further preference the weft count is 70 to 80 and/or the warp count is 70 to 80.

As backing material for the stamped product it is possible in addition to use all known textile backings, such as wovens, knits or nonwoven webs; the term “nonwoven web” embraces at least textile sheetlike structures in accordance with EN 29092 (1988) and also stitchbonded nonwovens and similar systems. It is likewise possible to use spacer fabrics, including wovens and knits, with lamination.

Starting materials envisaged for the textile backing include, in particular, polyester, polypropylene, viscose, staple rayon or cotton fibers. The present invention is, however, not restricted to said materials; rather it is possible to use a large number of other fibers to produce the web, as is evident to the skilled worker without any need for inventive activity. What is important is that the materials used have the requisite heat resistance.

Particularly advantageous for the concept of the invention is a nonfogging stamped product, comprising a nonfogging backing applied to at least one side of which is a nonfogging, pressure-sensitive adhesive.

As adhesives on the backing it is possible in principle to choose a variety of polymer systems, with natural-rubber or synthetic-rubber and also acrylate systems having proven particularly advantageous if their adhesive properties and temperature stabilities are in accordance with the requirements. With further preference the bond strength to steel is at least 5 N/25 mm.

A suitable adhesive is one based on acrylate hotmelt which has a K value of at least 20, in particular more than 30 (measured in each case in 1% strength by weight solution in toluene, 25° C.), obtainable by concentrating a solution of such an adhesive to give a system which can be processed as a hotmelt.

Then, it is possible to use an adhesive composed from the group of the natural rubbers or synthetic rubbers or composed of any desired blend of natural rubbers and/or synthetic rubbers, it being possible to select the natural rubber or the natural rubbers in principle from all available grades, such as, for example, crepe, RSS, ADS, TSR or CV grades, depending on the required purity and viscosity level, and to select the synthetic rubber or synthetic rubbers from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate (EVA) copolymers and polyurethanes and/or blends thereof.

With further preference it is possible to add thermoplastic elastomers to the rubbers, in order to improve the processing properties, with a weight fraction of from 10% to 50% by weight, based on the total elastomer fraction.

As representatives mention may be made at this point in particular of the especially compatible styrene-isoprene-styrene (SIS) and styrene-butadiene-styrene (SBS) products.

Tackifying resins which can be used include without exception all tackifier resins which are already known and have been described in the literature. As representatives mention may be made of the rosins, their disproportionated, hydrogenated, polymerized, and esterified derivatives and salts, the aliphatic and aromatic hydrocarbon resins, terpene resins and terpene-phenolic resins. Any desired combinations of these and further resins may be used in order to adjust the properties of the resultant adhesive in accordance with requirements. Express reference may be made to the depiction of the state of the art in the “Handbook of Pressure Sensitive Adhesive Technology” by Donatas Satas (van Nostrand, 1989).

The heat-activable adhesive sheets have preferably the following composition:
i) a polymer, with a fraction of at least 30% by weight, the first section of the heat-activable adhesive sheet being based with particular preference on reactive polyurethane, polyamide, nitrile rubber with reactive phenolic resins or reactive epoxy resins, and/or the second section being based on thermoplastic, non-reactive polyamides or epoxides,
ii) one or more tackifying resins, with a fraction of 5% to 50% by weight, and/or
iii) epoxy resins with hardeners, and accelerators too if desired, with a fraction of 5% to 40% by weight.

The adhesive sheets preferably have a thickness of from 10 to 500 μm.

The reactive adhesive sheet is a mixture of reactive resins which at temperatures above 120° C. crosslink and form a three-dimensional, high-strength polymer network, and of permanently elastic elastomers, which counter embrittlement of the product and therefore allow permanent loads (compressions, extensions) on the product.

The elastomer comes preferably from the group of polyolefins, polyesters, polyurethanes or polyamides, or may be a modified rubber, such as, for example, nitrile rubber, or else polyvinyl butyral, polyvinyl formal, polyvinyl acetate, or carboxylated or epoxylated SEBS polymer.

Indicated above are in each case the elastomers with which the stamped product develops particularly advantageous properties.

As a result of the chemical crosslinking reaction (based on epoxides or phenolic resin condensation) of the resins at elevated temperature, high strengths are achieved between the adhesive film and the surface where bonding is to take place, and the product attains a high internal strength.

The addition of the reactive resin/hardener systems also leads to a reduction in the softening temperature of the abovementioned polymers, which advantageously lowers their processing temperature and processing speed. The suitable product is a product which is self-adhesive at room temperature or slightly elevated temperatures. When the product is heated there is also, on a short-term basis, a lowering of the viscosity, as a result of which the product is able to wet rough surfaces as well.

The compositions for the adhesive sheet can be widely varied by changing the type and proportion of raw materials. It is also possible to obtain further product properties such as, for example, color, thermal conductivity or electrical conductivity, by means of selective additions of dyes, mineral and/or organic fillers, silicon dioxide for example, and/or powders of carbon and/or of metal.

Adhesive sheets are therefore distinguished by a series of advantages:
They possess high cohesion and elasticity at room temperature.
They exhibit high adhesion to the typical substrates in automobile construction.

The stamped product is permanently joined to the bodywork by exposing the stamped product to high temperatures for a short time, these temperatures leading to the activation of one or both adhesive sheets. Temperatures above 120° C. and below 200° C. have proven particularly advantageous, and the exposure to such temperatures should be approximately 20 minutes.

Particularly in the case of heightened mechanical stress, the stamped product of the invention is superior to the solutions known from the prior art. The same applies in consideration of noise suppression. Noise suppression and strength are massively improved through the combination of base layer/adhesive sheet(s)/laminar body. In addition it is possible for a single embodiment of the stamped product to cover a multiplicity of different-sized holes.

The stamped product is distinguished by:
very high load-bearing capacity/puncture resistance
very good sealing with respect to moisture/moisture barrier
effective sealing with respect to noise/sound deadening
simple and inexpensive facility, by laminated incorporation of heavyweight materials, metal platelets for example, for achieving an additional high strength of the assembly and an attenuation of noise.

Below, with reference to a FIGURE, the stamped product for permanently obturating holes, especially in metal sheets or plastic parts of automobile bodies, will be illustrated in greater detail, without any intention that this should in any way have a restrictive effect.

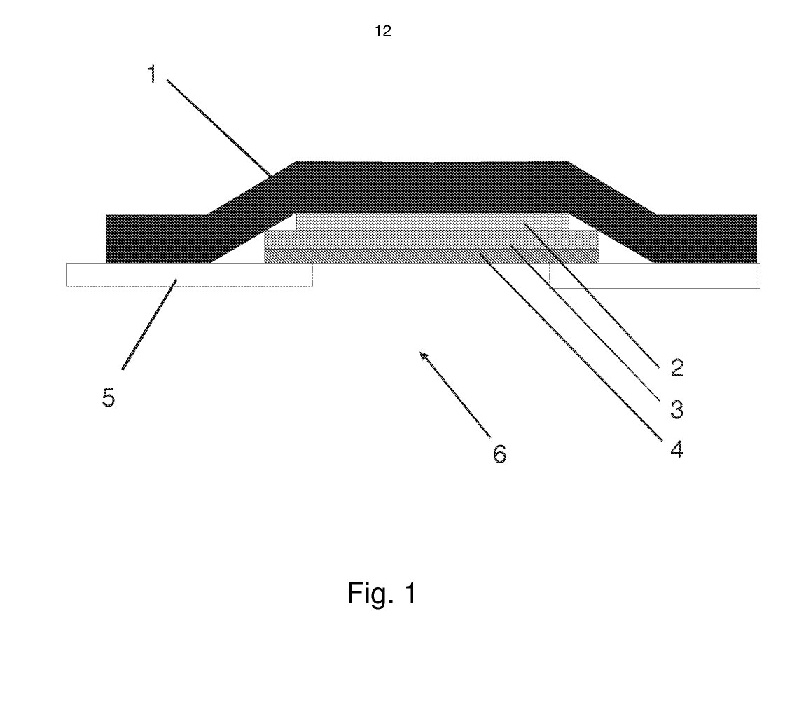

FIG. 1 shows the state after the hole to be obturated has been obturated by exposure to heat.

In the body 5, as a result of the construction system, there is a hole 6 requiring obturation.

For this purpose a stamped product with a base layer 1 which has a woven textile backing treated with an adhesive layer is fixed to the hole 6 in such a way that the hole 6 is completely covered by the stamped product.

The area of the stamped product is greater than the area of the hole 6 to be obturated.

Located centrally on the base layer 1, and on the adhesively treated side, is a laminar metal body 2.

Present on the metal platelet 2 is a first section 3 of a heat-activable adhesive sheet whose area is greater than the area of the hole 6 that is to be obturated and less than the area of the base layer 1, but greater than the laminar body 2.

On the first section 3 of the heat-activable adhesive sheet there is a second section 4 of a heat-activable sheet, having the same dimensions as the first section 3.

The stamped product is permanently joined to the bodywork 5 by exposure of the stamped product for a short time to high temperatures, which lead to the activation of the adhesive sheets 3, 4.

1. A stamped product for permanently obturating holes, having comprising an at least partly single-sidedly self-adhesively treated base layer comprising a heat-resistant backing whose area is greater than the area of a hole to be obturated and which is provided on the adhesively treated side with a first section of a heat-activable adhesive sheet whose area is greater than the area of the hole to be obturated and less than the area of the base layer, the stamped product being applied over the hole to be obturated in such a way that the hole is substantially covered by the first section.

2. The stamped product of claim 1, wherein on the first section of the heat-activable adhesive sheet, and on the side facing the hole, there is a second section of a thermoplastic heat-activable adhesive sheet, whose area is greater than the area of the hole to be obturated and less than the area of the base layer, the stamped product being applied over the hole to be obturated in such a way that the hole is substantially covered by the second section.

3. The stamped product of claim 1, wherein between the base layer and the first section of the heat-activable adhesive sheet there is a laminar body.

4. The stamped product of claim 1, wherein the heat-activable adhesive sheets have the following composition:
a polymer, with a fraction of a least 30% by weight, the first section of the heat-activable adhesive sheet being based on reactive polyurethane, polyamide, nitrile rubber with reactive phenolic resins or reactive epoxy resins, and/or the second section being based on thermoplastic polyamide or epoxide,
one or more tackifying resins, with a fraction of 5% to 50% by weight, and/or
epoxy resins with hardeners, and accelerators too if desired, with a fraction of 5% to 40% by weight.

5. The stamped product of claim 1, wherein the adhesive sheets have a thickness of from 10 to 500 μm.

6. The stamped product of claim 1, wherein the backing material comprises an aluminum foil, a textile backing or a polymeric film.

7. The stamped product of claim 3, wherein the laminar body is composed of metal.

8. The stamped product of claim 6, wherein the backing material is selected from the group consisting of PVC, PP, PET, PU and woven cotton fabrics having a weft count of 70 to 80 and/or a warp count of 70 to 8
